(19) United States
(12) Patent Application Publication
(10) Pub. No.: US 2008/0128528 A1
(43) Pub. Date: Jun. 5, 2008

(54) Fluid spraying system

(76) Inventors: Salvatore A. Alongi, Garden City, MI (US); Daniel R. Kramer, Huntington Woods, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/946,455

(22) Filed: Nov. 28, 2007

Related U.S. Application Data
(60) Provisional application No. 60/861,613, filed on Nov. 28, 2006.

(51) Int. Cl. B05B 7/00

(52) U.S. Cl. 239/8; 239/331; 239/135; 239/69; 239/419.3

(57) ABSTRACT

A fluid spraying system for applying a spraying solution to an area under low pressure. The system includes at least one supply device for providing an aqueous solution and one or more compounds to create the spraying solution. A mixing device is configured to mix and inject the aqueous solution and one or more compounds into the container to create the spraying solution. A distribution system in communication with the container includes at least one distribution conduit to remove the spraying solution from the container. One or more delivery devices in communication with the at least one distribution conduit apply the spraying solution under low pressure to the area.

### CROSS-REFERENCE TO RELATED APPLICATIONS

This application claims the benefit of U.S. provisional application Ser. No. 60/861,613 filed Nov. 28, 2006.

### BACKGROUND OF THE INVENTION

1. Field of the Invention

The present invention relates generally to a fluid spraying system and, more particularly, to a system and method for applying a fluid solution under low pressure to treat an area or materials.

2. Background Art

Waste materials generated by commercial and personal uses are typically disposed of through standard practices, such as depositing refuse in landfills and passing waste byproducts through waste streams towards sewage plants. The content and resulting decomposition of the waste materials create less than desirable results, generating byproduct odors that are objectionable to workers in commercial industries and homeowners residing adjacent landfills and waste treatment facilities. Further, these waste byproducts such as gases, dust, insects and odors may present potential occupational hazards to workers, creating unsafe working conditions that could cause businesses to cease operations until the condition is resolved.

There are numerous systems and methods for treating waste materials using a variety of systems applying chemical compounds and formulas. In general, most of these systems require a high pressure delivery system that mixes and applies a chemical compound or mixture with a solution or liquid to the material. One limitation of the equipment used to create the high pressurized fluid stream is that high pressure units are more hazardous to operate and maintain. High pressure units can cause injuries to the workers adding the formulas to the system. Further, the costs of operating and maintaining this equipment are relatively high, making many of these systems unfeasible for small businesses operating with limited budgets.

Another limitation of current spraying systems is that the devices are unable to operate at temperatures near or below freezing (32° Fahrenheit, 0° Celsius). High pressure system operating at or below these temperatures can cause significant damage to the machines if the fluid transmitted if the system freezes up, thereby causing damage to critical supply lines and equipment such as pumps and nozzles.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 is a perspective view of an exemplary fluid spraying system;

FIG. 2 is a schematic diagram of the fluid spraying system; and

FIG. 3 is an illustration of another exemplary fluid spraying system.

### DETAILED DESCRIPTION OF THE PREFERRED EMBODIMENT(S)

Referring now to the Figures, a fluid spraying system for treating an area or material with a fluid compound or spraying solution under low pressure is disclosed. It is understood that the fluid spraying system may be used in any number of applications to treat, deodorize, disinfect or control materials in a defined area or the area itself, including, but not limited to, landfills, refuse transfer facilities, waste water treatment facilities, greenhouses, mills and animal feeding and processing operations.

In the following description, various operating parameters and components are described for a number of constructed embodiments. These specific parameters and components are included as examples and are not meant to be limiting. More specifically, directional language such as “left”, “right”, “above”, “below”, “upper”, “lower” and words of similar import designate directions shown in the drawings. Such directional terminology is used for clarity and is not intended to strictly limit the orientation of any aspect of the invention to a particular plane or direction.

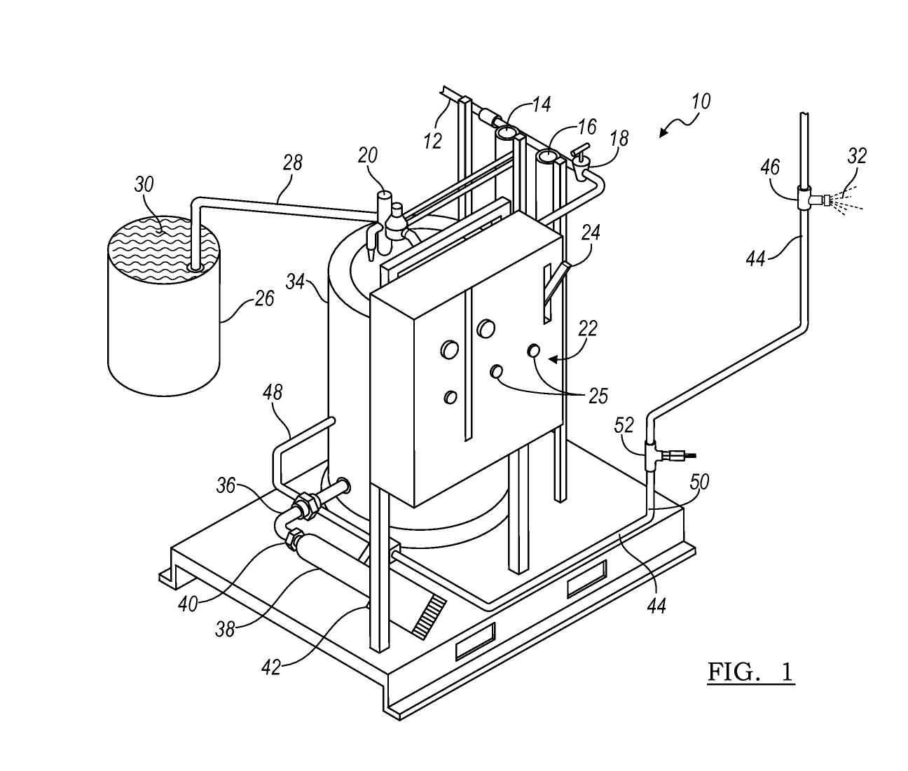

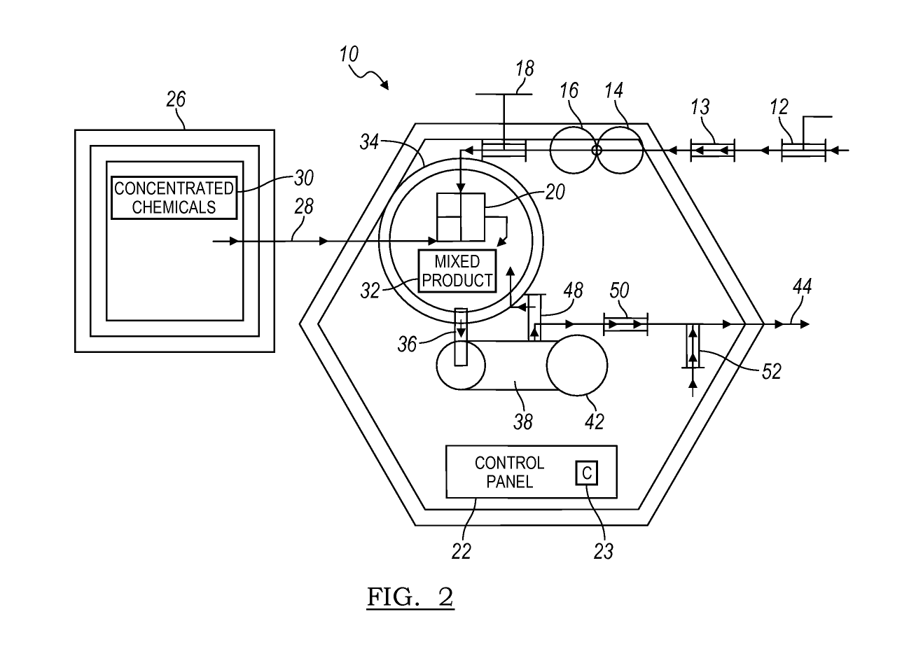

Referring now to the Figures, a fluid spraying system and method of treating an area with a spraying solution using a low pressure spraying system is disclosed and illustrated. Referring now to FIGS. 1 and 2, an exemplary spraying system for use with the present invention is illustrated. It is understood that system 10 may include a variety of components. These components are discussed herein for exemplary purposes only and can be readily interchanged or reconfigured to accomplish the same objective.

System 10 is connected to at least one supply device. As illustrated in the Figures, the at least one supply device includes a first supply device having supply conduit or line 12, such as a fluid line, hose or the like, that supplies an aqueous solution for use in the treatment process. Supply line 12 may be configured for connection to a standard municipal water supply line to provide the aqueous solution, such as water, for use in the mixing process. It is also understood that the aqueous solution could be supplied from another source, such as a storage container or the like. For purposes of explanation, the aqueous solution will be referred to as water below. However, it is understood that the aqueous solution may include a mixture of water with one or more chemical compounds to accomplish the same objective.

Supply line 12 may include one or more valves 13 for controlling the flow of the aqueous solution. Water flows through the supply line under pressure towards one or more filtering devices 14. The one or more filters 14 are configured to screen particulates from the water prior to application in the mixing process. In one aspect of the invention, a pair of filters, 14, 16 may be connected to the supply line. Filters 14, 16 each incorporate a distinct type of filter to provide a dual screening of the water prior to mixing with a chemical compound. In one exemplary application, a first filtering device may incorporate a 20 micron filter, while a second filter provided downstream from the first filter may incorporate a 5 micron filter to secondarily screen smaller impurities from the water. It is understood that the filter tolerances can be adjusted based on any number of factors or can be eliminated from the system without affecting the performance of system 10.

A pressure regulating valve 18 may be provided on supply line downstream from the one or more filtering devices 14. Valve 18 may be configured to force water towards a mixing device, such as a mixing valve or injector 20 at an appropriate pressure level for use in the mixing process. The pressure level may be adjusted to accommodate the types of chemicals being used or other modifications to the system 10. In one aspect of the present invention, the pressure regulating valve forces the water toward the mixing valve under low pressure in a range of about 20 to 60 lbs per square inch (psi), with an optimal pressure of about 40 psi. This range may also be applicable to the pressure applied by the one or more pumps as described below.

System 10 includes a control panel 22 allowing a user to adjust various settings on the system and to evaluate indications provided by one or more sensors connected to the system 10. A description of the sensors and alarms will be provided in greater detail below. Control panel includes a controller 23 that controls among other tasks the mixing process, pressures used in the system and application of the spraying solution to waste material. Control panel 22 may also include various controls and other elements that assist in the operation of the system such as an electrical main disconnect switch 24 and one or more condition indicators 25.

System 10 may also includes a second supply device such as a storage container 26 in communication with the mixing valve 20 through a supply conduit or hose 28. Storage container 26 may be configured to have a cavity to retain a supply of chemicals or compounds 30 for use in the mixing and spraying process. Hose 28 is connected to the injector mixing valve 20 at a first end and extends into the storage container 26 at a second end. The second end of the hose may include a venturi or suction device (not shown). Alternatively, the hose may include one or valves that allow the chemicals to be gravity fed to injector mixing valve.

Mixing device 20 may be configured from individual components or purchased as a commercial unit, such as the Hydrosystems, Inc. Hydrominder mixing valve. The mixing valve 20 forces water from the supply line 12 and chemicals from hose 28 together under pressure to mix the water and chemicals to create a spraying solution 32. The spraying solution 32 is stored in retaining tank 34. Mixing valve may include a magnetically actuated valve that may be in communication with and selectively opened by the controller to complete the mixing process. The valve may terminate the flow of mixed spraying solution when the liquid level in the tank reaches a predetermined height. It is also understood that the chemicals could be added after water is discharged from the mixing valve to accomplish the same objective.

System 10 may include one or more sensors in communication with the controller in control panel 22 to detect various conditions of the system. For example, one or more sensors may be disposed in the storage container 26 or retaining tank 34 to evaluate whether the materials in either the container 26 or tank 34 have fallen below a predetermined level. It is understood that various types of sensors and sensing devices may be used to accomplish this purpose.

For example, the sensing device may include a float disposed within the container and/or tank. The float is buoyant in relation to the materials stored in the container and/or tank and may be made of any suitable lightweight material, such as a hollowed polymeric structure, Styrofoam, wood or other material that may include material inside to provide sufficient displacement to support the float and its associated components in the spraying solution. Alternatively, various electro mechanical sensors may be disposed in the container and/or tank, as well as on the supply end output lines to provide information to the controller.

The spraying system may further include one or more notification systems in communication with the controller to identify potential issues and notify appropriate personnel of possible maintenance issues. One example of such a system may include a weather notification component incorporating an anemometer connected to a wireless transmitter. A receiver connected to the controller receives data from the transmitter, and, depending on conditions programmed in the controller, may automatically activate cold temperature components such as the air compressor or heat trace system as described below. Alternatively, the controller may activate one or more alarm output modules to notify an operator of a condition.

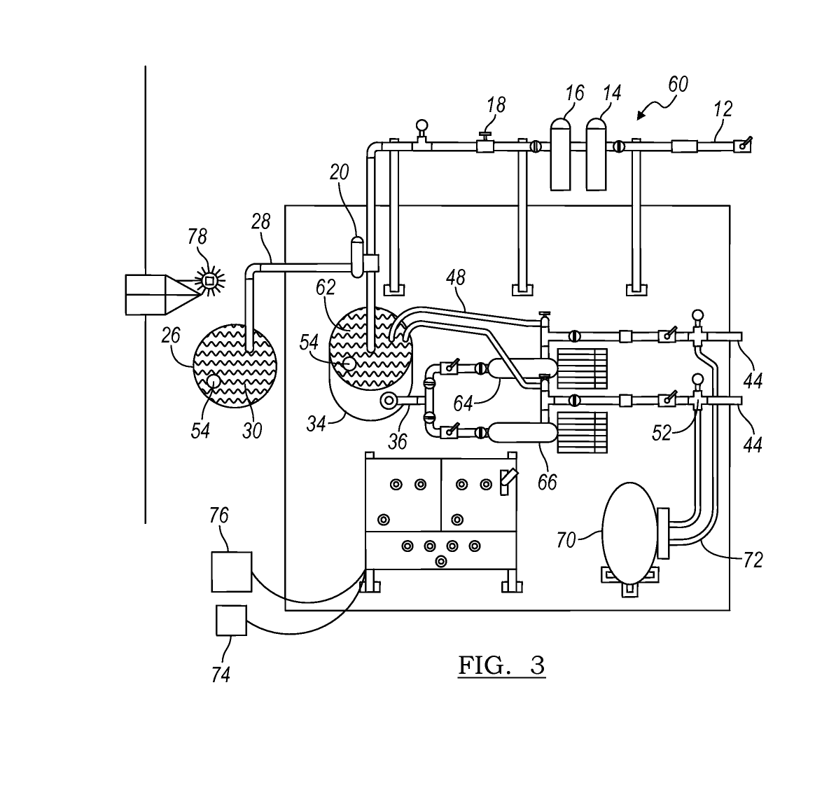

System 10 further includes a distribution system having at least one distribution or supply conduit 36 connected to tank 34 at a first end and one or more pumps 38 at a second end. Inlet port 40 supplies the mixed spraying solution from the conduit to pump 38. A motor 42 may be operatively connected to the one or more pumps 38. When activated, the motor 42 causes pump 38 to remove the spraying solution 32 from the storage container 26 through the at least one distribution conduit or supply line 44 towards one or more spray nozzles 46. The number and capacity of the pumps can be adjusted based on the application for use. For example, a single motor and pump may be sufficient to treat a defined area in the range of 0 to about 1,500 feet. Alternatively, as illustrated in FIG. 3, multiple pumps and motors can be implemented to increase the range of the distribution system. The flow rates of the pumps can also be selected based on the type of application. Further, the one or more pumps may include one or more sensors in communication with the controller to monitor the status of the pump.

The distribution system may also include a pressure relief valve return line 48 that is connected at a first end to the pump 38 and the tank 34 at a second end. The pressure relief valve return line 48 returns spraying solution 32 to tank 34 that is unused by pump 38. In one aspect of the present invention, supply line 44 includes one or more valves 50 that provide secondary relief and control of the supply line 44. In another aspect of the present invention, an inlet 52 may be provided on supply line 44 that allows for connection of an air compressor to flush the system for maintenance purposes. This aspect of the invention will be described in greater detail below.

The mixed spraying solution is forced through the at least one distribution conduit 44 towards the one or more delivery devices 46, such as a spray nozzle for treatment of waste material. It is understood that the particle droplet size can be adjusted based on the opening provided in the nozzle. In one aspect of the present invention, it is contemplated that the particle droplet size may be about 20 to about 75 microns depending on the pressure applied (as described above) through the supply line. It is also understood that the spraying solution may be applied in distinct steps by separate delivery devices, or alternatively, simultaneously by the same plurality of delivery devices. Any variety of the applications described above can be used to accomplish the same objective contemplated herein.

Referring now to FIG. 3, an alternative aspect of the fluid spraying system is illustrated and disclosed. Components previously described above having similar functions described below are given the same numbers for reference purposes. Fluid spraying system 60 contemplates the use of multiple pumps for application of a solution on a larger defined area. An aqueous solution is supplied to system 60 through a supply line 12 and is filtered by one or more filters 14, 16, prior to application to the injector mixing valve 20 by pressure regulating valve 18. Controller in control panel 22 causes mixing valve 20 to draw chemicals 30 through conduit 28 for mixing with the water supplied by regulating valve 18 by mixing valve 20. The mixed spraying solution 62 is injected into tank 34 by mixing valve 20.

As described above, one or more sensors may be used to detect the amount of solution 62 in tank 34. In one aspect of the invention, a float switch 54 may be provided in tank 34 and storage container 26 and is coupled to a sensor to detect the level of materials in container 26 and tank 34. The float switch sensor is interconnected to controller in control panel 22 and notifies the controller if the solution 62 or chemicals 30 fall below a predetermined level. Activation of this flow switch then causes mixing valve 20 to mix and add more chemicals 30 and water into tank 34 for use by the system 60 or to add more chemicals 30 to storage container 26.

The at least one distribution conduit 36 may be configured to supply spraying solution to first and second pumps 64, 66. Conduit 36 may include one or more valves 68 on each branch of the conduit that allows the operator to independently control flow of the spraying solution from tank 34 to the first and second pumps 64, 66. One or more motors are operatively connected to the pumps 64, 66 to direct spraying solution to the spray lines 44 and nozzles. System 60 further includes one or more pressure relief valves and return lines 48 that are connected at a first end to the pumps 64, 66 and the tank 34 at a second end. The pressure relief valve return line 48 returns spraying solution to tank 34 that is unused by pump 38.

In one aspect of the present invention, use of multiple pumps in a system allows for independent operation of the pumps and continuous use of the system in the event that one of the pumps requires maintenance or needs to be shut down. Independent control systems allow a single pump, or, in the case of systems with three or more pumps, multiple pumps to maintain operation of the system, and thereby, application of the spraying solution to material or a defined treatment area.

The at least one distribution conduit or supply line 44 may include one or more valves that provide secondary relief and control of the supply line 44. In another aspect of the invention, an inlet 52 provided on supply line 44 allows for connection of an air compressor to flush the system for maintenance purposes. The mixed spraying solution is forced through supply line 44 towards the one or more spray nozzles (not shown) for treatment of waste material.

The fluid spraying system illustrated in FIGS. 1-3 and described herein are related systems incorporating various features. It is understood that features described herein may be incorporated in either a single or multiple pump low pressure fluid spraying system. For purposes of explanation, FIG. 3 incorporates additional features of the system in accordance with the present invention that allow the present invention to operate in temperatures at or below freezing (32° Fahrenheit, 0° Celsius).

In one aspect of the present invention, an air compressor 70 may be operatively connected to the system 60 at inlet 52 by hose 72. Air compressor 70 may be manually operated or, as contemplated in FIG. 3, automatically operated and controlled by the controller in control panel 22. The controller is in communication with and maintains control of air compressor 70 through an interface shown in block 74. Interface 74 may include one or more sensors that monitor the condition of the air compressor. Air compressor 70 assists in maintaining the spraying system by forcing air through the supply lines to clear any blockages.

In another aspect of the invention, the spraying system may include a heating component that maintains the supply lines and hoses of the system at a temperature which eliminates the possibility of spraying solution or other materials that might freeze in the lines. The heat trace component includes an interface 76 in communication with the controller in control panel, one or more heat trace cables, insulation materials and one or more sensors. The controller may monitor the one or more sensors to determine the temperature in and/or around the supply lines and activate the heat trace interface 76 should the lines need to be heated.

In yet another aspect of the invention, a heating system may be coupled with the system to maintain the water temperature above a level that allows use of the system in temperatures at or below freezing. The heating system may comprise a number of systems, including a boiler system with a recirculation pump. Alternatively, heating elements may be directly connected to the water supply lines and/or solution supply lines to maintain the temperature of the fluid in the lines.

It is contemplated that the spraying system may incorporate a monitoring component that detects various conditions and notifies an operator of a condition. In one exemplary embodiment, the monitoring component includes a visual and audible notification device 78, such as a strobe light and horn, that is mounted in a position to notify operators of potential issues detected by the system. The monitoring component evaluates data transmitted by the one or more sensors to the controller. If the controller detects a change in the data received from the sensors that indicates a potential issue, the controller communicates with the monitoring component to generate notifications.

In addition to the notifications presented on the indicator lights on the control panel 22 and notification device 78, the monitoring component may also transmit a notification to the operator via a standard communication interface and/or device. For example, the monitoring component may transmit a notification regarding a condition by text message to a wireless communication device, send an email to a computing device and/or transmit a voice message to a wired or wireless communication device. Further, it is contemplated that the controller of the present invention may be in communication with and monitored by the system manufacturer's or owner's technical support computing system. It is also contemplated that a remote computing system could access, monitor and manage the controller of the system as an additional support resource.

As discussed herein, it is understood that the fluid spraying system may be used in any number of applications to apply a solution under low pressure regardless of atmospheric conditions. For example, the fluid spraying system could be used to apply a solution to control and/or reduce insects in an area or on a material. Alternatively, the fluid spraying system could apply a dust control solution to reduce the likelihood of particulates leaving an area or for erosion control. In another aspect of the invention, the low pressure fluid spraying system may be used to apply a solution to treat, deodorize, disinfect or control materials in a defined area or the area itself, including, but not limited to, landfills, refuse transfer facilities, waste water treatment facilities, greenhouses, mills and animal feeding and processing operations. to treat materials or an area. It is understood that this list is not fully inclusive of all applications of the fluid spraying system and that the system could be easily modified to achieve other objectives without departing from the scope of the invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A fluid spraying system comprising:
a container having a cavity defined therein operable to store a spraying solution;
at least one supply device for providing an aqueous solution and one or more compounds to create the spraying solution;
a mixing device operatively connected to one or more conduits of the at least one supply device and configured to mix and inject the aqueous solution and one or more compounds into the container to create the spraying solution;
a distribution system in communication with the container including at least one distribution conduit to remove the spraying solution from the container; and
one or more delivery devices in communication with the at least one distribution conduit,
wherein the spraying solution is applied under low pressure to an area by the one or more delivery devices.

2. The fluid spraying system of claim 1 further comprising a controller configured to monitor and control application of the spraying solution to the area by the distribution system.

3. The fluid spraying system of claim 2 wherein the controller is in communication with and monitors one or more sensors disposed in the container to determine the amount of spraying solution stored in the container.

4. The fluid spraying system of claim 1 wherein the first supply device further comprises one or more filters in communication with the one or more conduits to filter the aqueous solution prior to introduction in the mixing device.

5. The fluid spraying system of claim 1 wherein the one or more conduits of the first supply device further include a valve for regulating the pressure of the aqueous solution prior to introduction to the mixing device.

6. The fluid spraying system of claim 1 wherein the distribution system further comprises one or pumps configured to draw the spraying solution from the container through the at least one distribution conduit to be forced through the one or more delivery devices under low pressure.

7. The fluid spraying system of claim 6 wherein one or more motors are operatively connected to the one or more pumps to force the spraying solution through the at least one distribution conduit.

8. The fluid spraying system of claim 2 wherein an air compressor in communication with the controller is operatively connected to the at least one distribution conduit through an inlet to force air through the at least one distribution conduit to remove materials from the conduit.

9. The fluid spraying system of claim 2 further comprising a heat trace component in communication with the controller configured to heat the at least one distribution conduit.

10. The fluid spraying system of claim 9 wherein the controller activates the heat trace component upon detection of a temperature condition by one or more temperature sensors in communication with the controller.

11. The fluid spraying system of claim 2 further comprising a monitoring component in communication with the controller configured to generate a warning upon detection of a fault condition by the controller.

12. A fluid spraying system configured for mixing and distributing a solution under low pressure for treatment of an area, the system comprising:
a container having a cavity defined therein;
a first supply device including one or more conduits for providing an aqueous solution;
a second supply device including one or more conduits for providing one or more compounds;
a mixing device operatively connected to the one more conduits of the first and second supply devices configured to mix and inject the aqueous solution and one or more compounds into the container to create a spraying solution;
a distribution system in communication with the container having one or pumps configured to remove the spraying solution from the container through at least one distribution conduit;
a controller configured to control application of the spraying solution to the area by the distribution system; and
one or more delivery devices in communication with the at least one distribution conduit;
wherein one or more pumps forces the spraying solution under low pressure through the one or more spraying solution on to the area.

13. The fluid spraying system of claim 12 wherein the controller is in communication with and monitors one or more sensors disposed in the container to determine the amount of spraying solution stored in the container.

14. The fluid spraying system of claim 12 wherein the first supply device further comprises one or more filters in communication with the one or more conduits to filter the aqueous solution prior to introduction in the mixing device.

15. The fluid spraying system of claim 12 wherein the one or more conduits of the first supply device further include a valve for regulating the pressure of the aqueous solution prior to introduction to the mixing device.

16. The fluid spraying system of claim 12 wherein an air compressor in communication with the controller is operatively connected to the at least one distribution conduit through an inlet to force air through the at least one distribution conduit to remove materials from the conduit.

17. A method of applying a spraying solution under low pressure to an area, the method comprising:
providing a container having a cavity configured to receive the spraying solution;
supplying an aqueous solution and one or more compounds to a mixing device through at least one supply devices;
providing a mixing device configured to inject the aqueous solution and one or more compounds through the mixing device into the container to create the spraying solution;
removing the spraying solution from the container through at least one distribution conduit using one or more pumps; and
applying the spraying solution under low pressure to the area through one or more delivery devices in communication with the at least one distribution conduit.
wherein one or more pumps forces the spraying solution under low pressure through the one or more spraying solution on to the area.

18. The method of claim 17 wherein the step of supplying the one or more compounds further comprises supplying a compound to create a spraying solution for deodorizing and disinfecting the area.

19. The method of claim 17 wherein the step of supplying the one or more compounds further comprises supplying a compound to create a spraying solution to control and reduce loose particulates and dust in the area.

20. The method of claim 17 wherein the step of supplying the one or more compounds further comprises supplying a compound to create a spraying solution to control and reduce insects in the area.
